(19) United States
(12) Patent Application Publication
(10) Pub. No.: US 2008/0172505 A1
(43) Pub. Date: Jul. 17, 2008

(54) ELECTRONIC DEVICE, CONTROL METHOD, AND PROGRAM PRODUCT

(76) Inventor: Manabu Kiri, Kanagawa (JP)

Correspondence Address: Frank Pincelli;Patent Legal Staff, Eastman Kodak Company, Rochester, NY, 14650-2201, US

(21) Appl. No.: 11/623,420

(22) Filed: Jan. 16, 2007

(51) Int. Cl. G06F 13/12

(52) U.S. Cl. 710/74

(57) ABSTRACT

An electronic device controlled by control software stored in a volatile memory, wherein said software is retained in the memory and said electronic device is stopped after executing steps to initialize said software.

### CROSS REFERENCE TO RELATED APPLICATIONS

Reference is made to commonly assigned pending Japanese Patent Application No. 2004-121636 filed Apr. 16, 2004.

### FIELD OF THE INVENTION

The present invention relates to an electronic device managed by software, a control method for an electronic device, and a control program product for an electronic device.

### BACKGROUND OF THE INVENTION

Software controlled electronic devices require software initialization at the time of starting up the device. However, this software initialization processing takes time and the time the devices takes to start up therefore becomes long.

It has been possible to shorten processing time by omitting software initialization processing when restarting the software by entering a standby state where content of memory used by the software is retained while halting the device.

Further, in Japanese Patent Laid-open Publication No. Hei 8-161176, technology is disclosed where a restarting processing instruction string resides in instruction cache in order to perform high speed processing for the operating system when problems occur with the software.

However, there are problems with stability of the electronic device when this method is executed repeatedly, for example where memory content is retained and a standby state is entered while halting the electronic device. In particular, with electronic devices employing software not compatible with fragmentation of memory, such as with a real time operating system (RTOS) or electronic devices that only use stand-alone control software and do not utilize an operating system, memory fragmentation or the like occurs. Fragmentation occurs due to repeatedly entering a standby state, and it is possible that the system may no longer operate in a stable manner.

### SUMMARY OF THE INVENTION

The present invention is an electronic device controlled by control software stored in volatile memory, wherein said software is retained in memory and said electronic device is stopped after executing steps to initialize said software.

The present invention may be implemented by a control program product for an electronic device controlled by control software stored in volatile memory, wherein said software is retained in memory and said electronic device is stopped after executing steps to initialize said software.

### BRIEF DESCRIPTION OF THE DRAWINGS

FIG. 1 is a block view showing the configuration of an electronic device of an embodiment of the present invention;

FIG. 2 is a view showing a flowchart at the time of start-up of an electronic device of the embodiment of the present invention; and

FIG. 3 is a view showing a flowchart at the time of standby and the time of start-up of the electronic device of the embodiment of the present invention.

### DETAILED DESCRIPTION OF THE INVENTION

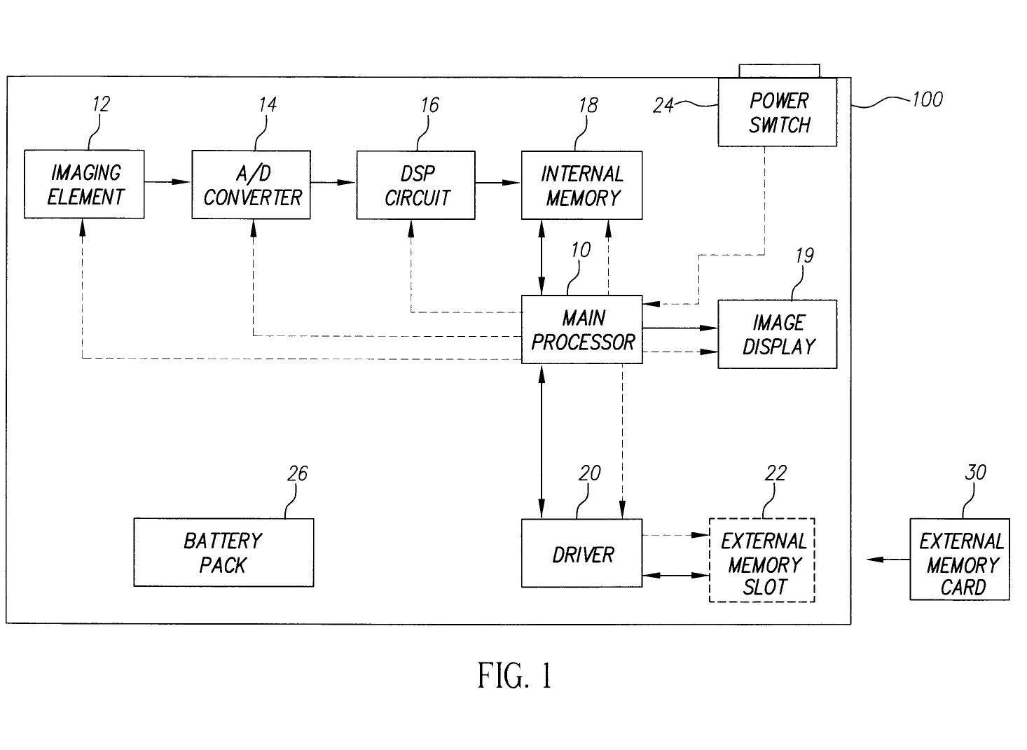

As shown in FIG. 1, an electronic device 100 of one of a preferred embodiment of the present invention is comprised principally of a main processor 10, imaging element 12, analog/digital converter (A/D converter) 14, digital signal processor (DSP) 16, internal storage 18, driver 20, external memory slot 22, power supply switch 24, and battery 26. In FIG. 1, image signals are shown by solid lines and control signals are shown by dashed lines.

As described above, in this embodiment, a description is given taking a digital camera as an example of the electronic device 100 but the present invention is by no means limited in this respect, and the present invention may similarly be applied to other electronic devices.

The following processing is capable of being implemented as a result of execution of an electronic device control program stored in internal storage 18 as a program capable of being executed using a microprocessor acting as the main processor 10.

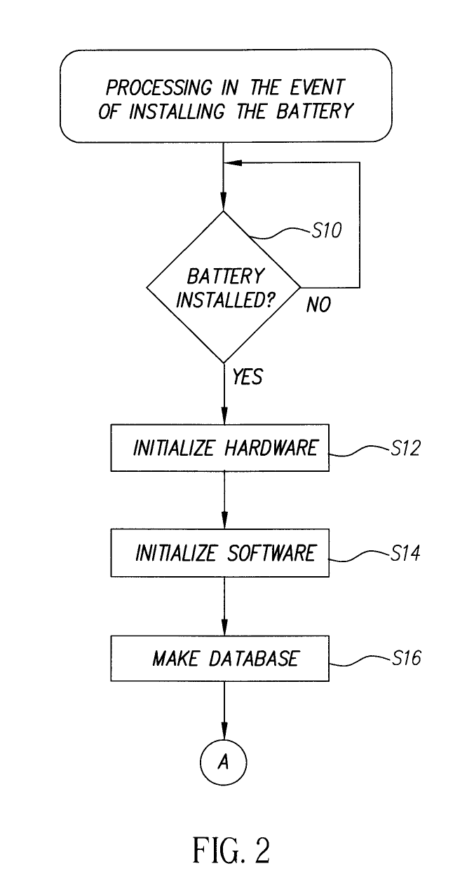

The electronic device 100 is initialized by installing the battery pack 26 and turning the power supply switch 24 on. A flowchart for the processing occurring when the battery is turned on is shown in FIG. 2.

In step S10, a determination is made as to whether or not the power supply switch 24 is on after the battery pack 26 is installed. When a prescribed amount of electrical power is supplied from the battery pack 26, the main processor 10 determines whether or not the power supply switch 24 is on. If the power supply switch 24 is on, the processing advances to step S12.

Hardware initialization is then carried out in step S12. In accompaniment with installation of the battery pack 26, a prescribed amount of electrical power is provided to each part of the electrical device 100. Initialization signals are sent from the main processor 10 to the imaging element 12, A/D converter 14, DSP 16, internal storage 18, image display 19, and driver 20, and each part of the electronic device 100 is initialized. Software initialization is then carried out in step S14. Control software is transferred to volatile memory (RAM) from the n on-volatile memory (ROM) of the internal storage 18 and setting of initialization values of the software etc., is carried out. Cache memory etc. of the main processor 10 is also cleared. Further, an operating system (OS) initialization routine is executed, and the OS is booted.

A database is then made in step S16 at the internal storage 18 or at the external memory card 30 installed in the external memory slot 22. When software initialization is complete, the main processor 10 ensures an area in the memory of the internal storage 18 and the external storage card 30, and sets a database region for storing and maintaining digital image data. This processing is necessary when the electronic device 100 is an imaging device such as a digital camera or the like and may be omitted for other electronic equipment.

A transition is made to normal processing when the processing at the time of battery installation is complete. Normal processing is described in the following.

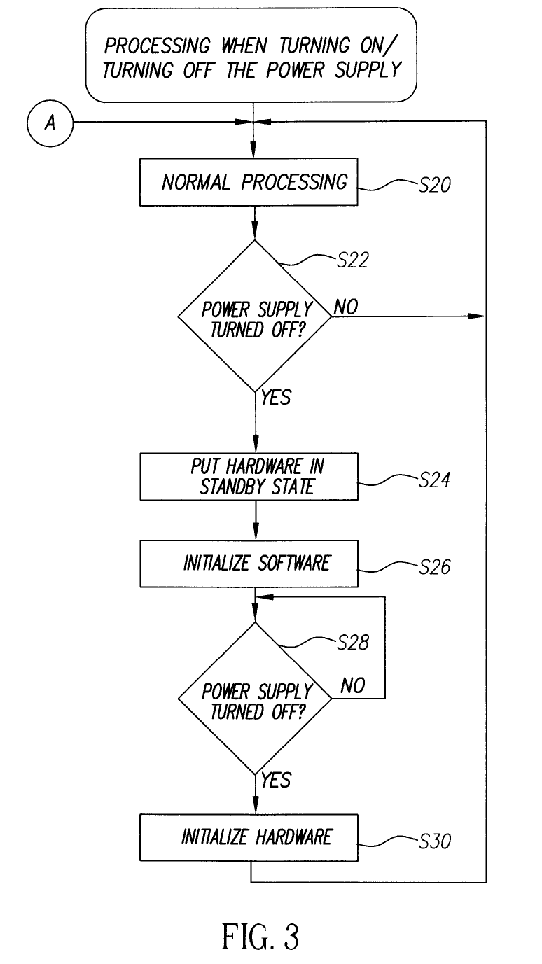

A flowchart showing processing at the time of normal turning on and turning off of the power supply is shown in FIG. 3. When the battery pack 26 is installed and initialization of the hardware and software is complete, the processing of step S20 is proceeded to, and normal imaging processing is executed.

In normal image processing, the imaging element 12, A/D converted 14, and DSP 16 receive control signals from the main processor 10, receiving signals from the shutter, take images of subjects, and acquire digital image data. The internal memory 18 temporarily stores digital image data 1, acquired at a database constructed in step S116. The image display 19 displays digital image data acquired by control of the main processor 10 receiving an image display instruction from a user using a touch panel (not shown) etc., or displays digital image data image processed by the main processor 10 as necessary. Further, the driver 20 receives a control signal from the main processor 10 and stores digital image data on the external memory card 30 inserted into the external memory slot 22 and reads digital image data from the external memory card 30. The control program stored in the volatile memory of the internal memory 18 can be executed at the main processor 10.

In step S22, a determination is made as to whether or not the power supply switch 24 is off. The main processor 10 receives a signal from the power supply switch 24 and determines whether or not the power supply switch is off. If the power supply switch 24 is off, the processing proceeds to step S24, and if the power supply switch 24 remains on, the normal processing of step S20 is continued.

In step S24, the hardware is put into a standby state. The main processor 10 sends standby signals to the imaging element 12, A/D converted 14, DSP 16, internal storage 18, image display 19, and driver 20, and each part of the electronic device 100 is put into a standby state.

Software initialization is then carried out in step S26. The control software is maintained, as is, in a volatile storage (RAM) and the setting of initialization values required during reactivation of the electronic device 100 is carried out. It is preferable for the software initialization to include processing for clearing at least part of a memory area other than the memory area in which the software is stored, for example, a cache memory area holding variable used in internal processing.

As a result, the hardware and software both enter a standby state. This embodiment has a further feature where in addition to software initialization being executed S26, software is put into a standby state when the power supply switch 24 is put off.

In step S28, a determination is made as to whether or not the power supply switch 24 is on. The main processor 10 receives a signal from the power supply switch 24 and determines whether or not the power supply switch is on. If the power supply switch 24 is turned on, the processing advances to step S30, and if the power supply switch 24 is turned off, the processing of step S28 is repeated, and a system standby state is maintained.

Hardware initialization is then carried out in step S30. the main processor 10 sends initialization signals to imaging element 12, A/D converter 14, DSP 16, image display 19 and driver 20 maintained in a standby state and executes initialization of each part of the electronic device 100. Further, a standby state cancel signal is sent to the RAM of the internal memory 18 and a state where access is possible is attained.

With regards to the software, when the power supply switch 24 is turned off, the initialization is complete, and imaging processing is possible immediately. When this processing ends, the processing advances to step S20, and normal imaging processing is carried out.

As described in the above, according to this embodiment, it is possible for restarting of a system to take place in both a rapid and stable manner by executing initialization of software in advance prior to putting the entire system into a standby state S24 when putting a power supply switch 24 off. As a result, for example, it is possible to rapidly restart an electronic camera from a standby state so as to ensure that very few good opportunities to take a photograph will be missed when taking pictures.

Further, memory fragmentation etc. does not occur even when the electronic device is repeatedly put into a standby state and it is possible for the system to operated in a stable manner. In particular, restarting that is fast and stable is possible for mobile electronic devices employing real-time operating (systems (RTOS) and mobile electronic devices that perform control using only stand alone control software and do not employ an operating system, and this increases the convenience of the electronic device.

### PARTS LIST

10 main processor
12 imaging element
14 A/D converter
16 DSP circuit
18 internal storage
20 driver
22 external memory slot
24 power supply switch
26 battery pack
30 external memory card
100 electronic device
S10 battery installed
S12 initialize hardware
S14 initialize software
S16 make database
S20 normal processing
S22 power supply turned off
S24 put hardware in standby state
S26 initialize software
S28 power supply turned on?
S30 initialize hardware

1. An electronic device controlled by control software stored in a volatile memory, comprising software retained in a memory; and an electronic device being stopped after executing steps to initialize said software.

2. The electronic device as claimed in claim 1, wherein said software initialization includes processing to clear at least part of a memory area other than a memory area storing said software.

3. The electronic device as claimed in claim 1, wherein said software is executed on a real-time operating system or without utilizing an operating system.

4. A control method for an electronic device controlled by control software stored in a volatile memory, wherein said software is retained in the memory and said electronic device is stopped after executing steps to initialize said software.

5. A control program product for an electronic device controlled by control software sorted in a volatile memory, wherein said software is retained in the memory and said electronic device is stopped after executing steps to initialize said software.
